(19) United States
(12) Patent Application Publication
(10) Pub. No.: US 2026/0134560 A1
(43) Pub. Date: May 14, 2026

(54) APPARATUS AND METHOD FOR POSITIONING INDOOR SPACE DATA BASED ON VISUAL SLAM

(71) Applicant: TSP XR, Nowon-gu (KR)

(72) Inventors: Chan Soo PARK, Gangbuk-gu (KR); Jin Kyu KANG, Yongsan-gu (KR); Hyeon Yong SON, Gwangju-si (KR)

(21) Appl. No.: 19/021,522

(22) Filed: Jan. 15, 2025

(30) Foreign Application Priority Data
Nov. 11, 2024 (KR) 10-2024-0159474

(51) Int. Cl. G06T 7/579; G06T 3/18; G06T 7/13; G06T 7/70; G06V 10/54; G06V 10/56; H04N 13/00; H04N 13/207

(52) U.S. Cl. CPC G06T 7/579; G06T 3/18; G06T 7/13; G06T 7/70; G06V 10/54; G06V 10/56; H04N 13/207; G06T 2207/30244; H04N 2013/0081

(57) ABSTRACT

The present disclosure is a data positioning apparatus including a stereo camera which acquires visual data corresponding to 2D and 3D, an inertial measurement unit which acquires inertia data corresponding to acceleration and angular velocity data, and a computing module which receives data acquired from the stereo camera and the inertial measurement unit and performs computation of a visual SLAM engine.

### CROSS-REFERENCE TO RELATED APPLICATIONS

This application claims the benefit of and priority to Korean Patent Application No. 2024-0159474 filed on Nov. 11, 2024, in the Korean Intellectual Property Office, the entire disclosure of which is hereby incorporated herein by reference.

### BACKGROUND

### Field

The present disclosure relates to a data positioning technique, and more particularly, to an apparatus and a method for positioning indoor space data based on a visual SLAM (simultaneous localization and mapping) which generate camera trajectory data and an indoor space 3D map.

### Description of the Related Art

The data positioning technique includes light detection and ranging (LiDAR), simultaneous localization and mapping (SLAM), LiDAR SLAM, visual odometry (VO), visual inertial odometry (VIO), and the like. The LiDAR is a remote sensing technique which uses laser light to accurately measure a distance to an object and obtains distance information by measuring a time taken to return from the object after emitting a laser pulse and identify a position and a shape of the object in a 3D space at a high resolution by this process. The SLAM is a technique which allows a robot or a mobile object to simultaneously estimate its own position in an unknown environment and build a map of a surrounding environment. The SLAM is especially important in indoor or a complex urban environment in which GPS signals do not reach and plays a key role in autonomous driving and robotics. The LiDAR SLAM is a technique which implements the SLAM using data acquired from the LiDAR sensor. Precise distance measurement capability of the LiDAR allows the robots or vehicles to generate 3D maps of the surrounding environment and estimate their positions in real time, simultaneously. VO is a technique of estimating a position and an orientation of a mobile object using a camera and calculates a movement path by analyzing changes between image frames which are continuously acquired from the camera. At this time, feature points in the image are tracked or changes in direct pixel values are used and VO is widely utilized to estimate the positions of robots or vehicles in an indoor environment where GPS signals are weak or do not reach. VIO is a technology which estimates a position and an orientation by converging VO and data of an inertial measurement unit (IMU) and more precisely and stably estimate the position by combining visual information of the camera, acceleration and angular velocity data of the IMU.

In addition, the visual SLAM is a technique which recognizes the position and the orientation of the camera using visual data in real time and is specifically, necessary to utilize the position and the orientation information of a capturing camera in a 3D space, such as autonomous driving, augmented reality (AR), and virtual reality (VR). The visual SLAM system of the related art may precisely estimate positions and orientations by utilizing equipment which may collect 3D information, such as LiDAR or RADAR, but there is a problem in that the 3D equipment cannot be utilized in a mobile application and web/app system. The process of converging and computing a general camera system (2D) and 3D data is very complex so that it is difficult to implant the system into the mobile device having a limited computing performance. Accordingly, it is necessary to develop and utilize a visual SLAM engine optimized to the mobile device in consideration of computing complexity.

### SUMMARY

An object of the present disclosure is to provide a visual SLAM system and a data positioning apparatus based thereon and a data positioning apparatus which provides a visual SLAM engine.

An object of the present disclosure is to provide a data positioning apparatus which records an RGB image, depth data, or inertial measurement unit (IMU) data and records camera trajectory data and a 3D map in real time by real-time scanning and camera pose estimation.

An object of the present disclosure is to provide a data positioning apparatus which may precisely track a camera trajectory by utilizing depth data with limited data positioning by means of a visual SLAM engine which uses an RGB image and IMU data.

Technical problems of the present disclosure are not limited to the above-mentioned technical problems, and other technical problems, which are not mentioned above, can be clearly understood by those skilled in the art from the following descriptions.

in order to achieve the above-described objects, according to a first aspect of the present disclosure, a data positioning apparatus includes a stereo camera which acquires visual data corresponding to 2D and 3D; an inertial measurement unit which acquires inertia data corresponding to acceleration and angular velocity data; and a computing module which receives data acquired from the stereo camera and the inertial measurement unit and performs the computation of a visual SLAM engine.

Desirably, the stereo camera may acquire an RGB image corresponding to 2D data and depth data corresponding to 3D data.

Desirably, the computing module may include a data input unit which receives an RGB image and depth data from the stereo camera and inertia data from the inertial measurement unit; a data computing unit which normalizes the RGB image and the inertia data; a pose estimating unit which estimates a pose with six degrees of freedom for a current frame using the normalized data; and a graph optimizing unit which updates a camera pose trajectory on the basis of the estimated pose.

Desirably, the data computing unit may perform a 2D convolution computation on the RGB data and extract image feature information corresponding to a texture, an edge, or a color pattern by the 2D convolution computation.

Desirably, the data computing unit may calculate a variance of the RGB data and update a weight to minimize a calculation error for the pose of the stereo camera according to the variance.

Desirably, the data computing unit may perform a 1D convolution computation on the inertia data and extract inertia feature information corresponding to a pattern or a change over time by the 1D convolution computation.

Desirably, the data computing unit may calculate an output value corresponding to a specific element on the basis of the inertia feature information and a previous viewpoint output result of a long short term memory, calculate a probability value by applying Gumbel-Softmax to the output value, and product the probability value and the output value to change the output value to 0 or 1 to determine whether to use the image feature information.

Desirably, the pose estimating unit may form a tensor by concatenating used image feature information determined to be used depending on whether to use the image feature information and the inertia feature information with a dimensional axis, acquire a current viewpoint output result of the long short term memory on the basis of the tensor and the previous viewpoint output result of the long short term memory, and represent the current viewpoint output result with a vector for each axis through a fully connected layer.

Desirably, the data positioning apparatus may further include a depth estimating unit which is an auto-encoder-based model to estimate a depth value from the RGB image and generate a depth map.

Desirably, the data positioning apparatus may further include an image warping unit which generates a warped image using the depth map received from the depth estimating unit and updates a pose on the basis of the warped image and a pose estimated by the pose estimating unit.

Desirably, the depth estimating unit may calculate a 3D point using a depth value for each pixel of the RGB image and the image warping unit may transform the 3D points into a target camera coordinate system by applying a predicted camera orientation transformation, acquire a pixel coordinate by projecting the transformed 3D points onto a target image plane, and generate a warped image by sampling a pixel value corresponding to the pixel coordinate from the target image.

Desirably, the graph optimizing unit may update a pose estimated for the current frame to the pose trajectory estimated for the previous frame, examine outlier data, and optimize the trajectory.

Desirably, the graph optimizing unit may optimize data for the estimated pose in real time on the basis of bundle adjustment (BA) and a loop closure algorithm when a loop is generated in the camera pose trajectory due to the accumulation of the estimated pose.

Desirably, the data positioning apparatus may further include a visualization module which visualizes data acquired from the stereo camera, the inertial measurement unit, or the computing module and outputs the data to a display.

Desirably, the visualization module may output a function of visualizing and outputting the RGB image, the depth map, or the point cloud acquired from the stereo camera and controlling an operation of the data positioning apparatus and a function for controlling a display screen.

in order to achieve the above-described objects, according to a second aspect of the present disclosure, a data positioning method which is performed in a computing module of a data positioning apparatus, includes: a step of receiving visual data corresponding to 2D and 3D acquired from a stereo camera and acceleration and angular velocity data acquired from an inertial measurement unit; and a step of performing a computation of a visual SLAM engine on the basis of the received data.

Desirably, the step of performing a computation of a visual SLAM engine may include: a step of normalizing an RGB image corresponding to the 2D data and inertia data corresponding to the acceleration and angular velocity data; a step of estimating a pose with six degrees of freedom for a current frame using the normalized data; and a step of updating a camera pose trajectory on the basis of the estimated pose.

Desirably, the step of performing a computation of a visual SLAM engine may further include: a step of estimating a depth value from the RGB image and generating a depth map; a step of generating a warped image using the depth map; and a step of updating a pose on the basis of the warped image and the estimated pose.

In order to achieve the above-described objects, according to a third aspect of the present disclosure, in a computer program stored in a computer readable medium, when an instruction of the computer program is executed, the data positioning method is performed.

According to the present disclosure as described above, a deep learning algorithm is applied to some modules which configure a visual SLAM to improve computation efficiency and accuracy.

Camera trajectory data generated according to the present disclosure may be utilized for study and development of AR, VR, or a digital twin and an indoor space 3D map is used to configure the virtual space.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIGS. 1 and 2 are block diagrams for an indoor space data positioning apparatus according to an exemplary embodiment of the present disclosure;

FIG. 3 is an exemplary diagram for explaining an indoor space data positioning apparatus according to an exemplary embodiment;

FIG. 4 is a block diagram for explaining a computing module according to an exemplary embodiment; and

FIG. 5 is a flowchart for explaining an indoor space data positioning method according to an exemplary embodiment.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Advantages and characteristics of the present disclosure and a method for achieving the advantages and characteristics will be clear by referring to preferable exemplary embodiments described below in detail together with the accompanying drawings. However, the present disclosure is not limited to the exemplary embodiment disclosed herein but will be implemented in various forms. The exemplary embodiments are provided by way of example only so that a person of ordinary skilled in the art can fully understand the disclosures of the present disclosure and the scope of the present disclosure. Therefore, the present disclosure will be defined only by the scope of the appended claims. Like reference numerals generally denote like elements throughout the specification. “and/or” includes each of mentioned items and all combinations of one or more components.

Although the terms “first”, “second”, and the like are used for describing various elements, components, and/or sections, these elements, components, and/or sections are not confined by these terms. These terms are simply used to distinguish one element, component, or section from another element, component, or section. Accordingly, a first element, a first component, or a first section which will be mentioned below may also be a second element, a second component, or a second section in the technical spirit of the present disclosure.

Further, in each step, numerical symbols (for example, a, b, c, etc.) are used for the convenience of description, but do not explain the order of the steps so that unless the context apparently indicates a specific order, the order may be different from the order described in the specification. In the present specification, in each step, numerical symbols (for example, a, b, and c) are used for the convenience of description, but do not explain the order of the steps so that unless the context apparently indicates a specific order, the order may be different from the order described in the specification.

The terms used in the present specification are for explaining the exemplary embodiments rather than limiting the present disclosure. Unless particularly stated otherwise in the present specification, a singular form also includes a plural form. The word “comprises” and/or “comprising” used in the present specification will be understood to imply the inclusion of stated constituents, steps, operations and/or elements but not the exclusion of the presence or addition of one or more other constituents, steps, operations and/or elements.

Unless otherwise defined, all terms (including technical and scientific terms) used in the present specification may be used as the meaning which may be commonly understood by the person with ordinary skill in the art, to which the present disclosure belongs. It will be further understood that terms defined in commonly used dictionaries should not be interpreted in an idealized or excessive sense unless expressly and specifically defined.

In the following description of the exemplary embodiment of the present disclosure, a detailed description of known configurations or functions incorporated herein will be omitted when it is determined that the detailed description may make the subject matter of the present disclosure unclear. Further, the terms to be described below are defined considering the functions in the exemplary embodiment of the present disclosure and may vary depending on the intention or usual practice of a user or operator. Accordingly, the terminology needs to be defined based on details throughout this specification.

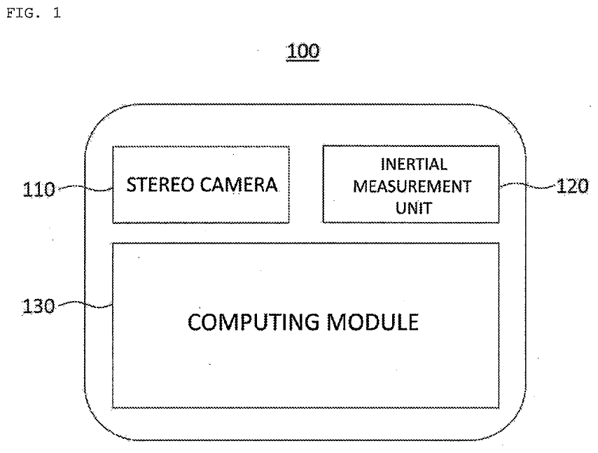

FIGS. 1 and 2 are block diagrams illustrating an indoor space data positioning apparatus according to an exemplary embodiment of the present disclosure.

An apparatus 100 for positioning indoor space data (hereinafter, referred to as “data positioning apparatus) is an apparatus for performing a method for positioning indoor space data (hereinafter, referred to as “data positioning method”) according to the present disclosure. Referring to a front part of the data positioning apparatus 100 illustrated in FIG. 1, the data positioning apparatus 100 includes a stereo camera 110, an inertial measurement unit 120, and a computing module 130.

The stereo camera 110 may acquire visual data corresponding to 2D and 3D and desirably, 2D data may correspond to an RGB image and 3D data may correspond to depth data.

The inertial measurement unit 120 acquires acceleration and angular velocity data.

The computing module 130 performs visual inertial odometry (VIO)-based visual SLAM engine computation on the basis of the RGB image and the depth data acquired from the stereo camera 110 and the acceleration and angular velocity data acquired from the inertial measurement unit 120, and for example, NVIDIA Orin NX 16 GB may be used. Desirably, the computing module 130 may estimate six degrees of freedom (6 DoF) of camera of an observer and here, among six degrees of freedom, three degrees of freedom is position and the remaining three degrees of freedom is orientation so that when the position and the orientation value are used, a capturing position of the camera viewpoint in the 3D space may be found out. The computing module 130 may analyze the difference between a previous viewpoint frame and a current viewpoint frame to estimate changes in the position and the orientation and the camera position estimated using the RGB image data and the inertia data together may be used to implement the visual-SLAM. Here, the simultaneous localization and mapping (SLAM) is a technique which estimates the position of the node (for example, robots or cameras) and creates a global map in real time using data acquired from the camera or the sensor. Visual SLAM refers to an SLAM which estimates the position using the camera data and in order to implement the visual SLAM, the position of the node may be precisely estimated.

Desirably, the computing module 130 is a computer which is executed by installing an application or a program to perform the data positioning method using data acquired from the stereo camera 110 and the inertial measurement unit 120 and includes a user interface to control the data input/output. Here, a computer refers to all types of hardware devices including at least one processor, and depending on the exemplary embodiment, is understood to include a software configuration which operates in the corresponding hardware device. For example, the computer is understood to include all smartphones, tablet PCs, desktops, laptops, and user clients and applications run in each device, but is not limited thereto.

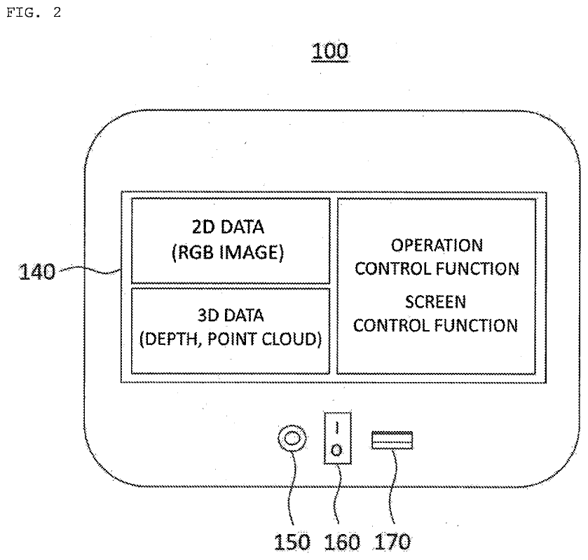

Referring to FIG. 2, as a rear part of the data positioning apparatus 100, the data positioning apparatus 100 includes a display 140, a power source 150, a power switch 160, and a USB port 170. Even though it is not illustrated in the drawing, the data positioning apparatus 100 may include a visualization module and when data acquired by the stereo camera 110, the inertial measurement unit 120, or the computing module 130 is visualized by the visualization module, the data may be output to the display 140. Desirably, the display 140 may output the RGB image, the depth map, or the point cloud which is acquired from the stereo camera 110 and is visualized by the visualization module and may output a function for controlling an operation of the data positioning apparatus 100 and a function for controlling a screen of the display 140. For example, referring to FIG. 3, when RGB data which is 2D data and depth data which is 3D data, or the point cloud, acquired from the stereo camera 110, are visualized by the visualization module, the display 140 may output it and may display whether the stereo camera 110 is interworked, whether the inertial measurement unit 120 is interworked, or a CPU/GUP usage rate, display functions, such as screen reduction, menu (option) setting, a scanning start button, or capture mode change, and output a data logging function. Further, the power source 150 and the power switch 160 support a wired/wireless power mode of the data positioning apparatus 100 and the USB port 170 supports the data interworking and extraction, and for example, may be External USB 3.0 port.

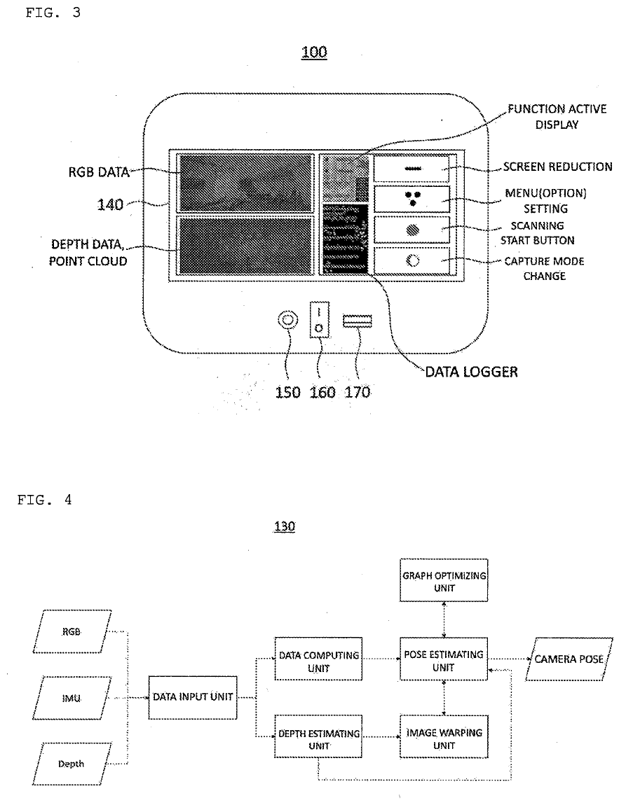

FIG. 4 is a block diagram for explaining a computing module according to an exemplary embodiment.

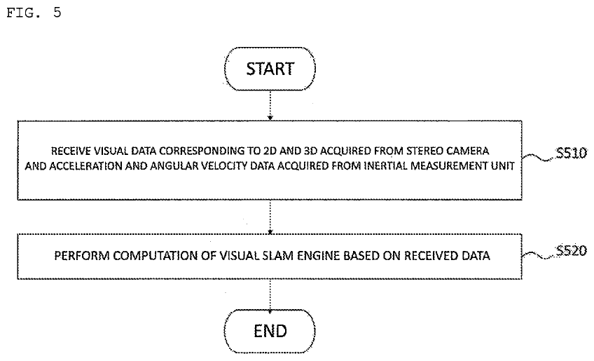

Referring to FIG. 4, the computing module 130 of the data positioning apparatus 100 includes a data input unit, a data computing unit, a pose estimating unit, a depth estimating unit, an image warping unit, and a graph optimizing unit. Even though it is not illustrated in the drawing, operations and data flows of the data input unit, the data computing unit, the pose estimating unit, the depth estimating unit, the image warping unit, and the graph optimizing unit are controlled by a controller. Hereinafter, an indoor space data positioning method which is performed by configurations of the computing module 130 will be described in more detail with reference to FIG. 5.

Referring to FIG. 5, the data input unit receives visual data corresponding to 2D and 3D acquired from the stereo camera 110 and inertia data corresponding to the acceleration and angular velocity data acquired from the inertial measurement unit 120 in step S510. That is, the data input unit receives an RGB image corresponding to 2D and the depth data corresponding to the 3D from the stereo camera 110 and receives the inertia data IMU from the inertial measurement unit 120.

The data computing unit, the pose estimating unit, the depth estimating unit, the image warping unit, and the graph optimizing unit perform the computation of the visual SLAM engine on the basis of the received data in step S520. The data computing unit normalizes data received by the data input unit, the pose estimating unit estimates a pose with six degrees of freedom (6 DoF) for a current frame using the normalized data, and the graph optimizing unit updates a camera pose trajectory on the basis of the estimated pose. Desirably, the computing module according to the present disclosure may use depth data to estimate a more precise camera pose by reducing an error when the indoor space data positioning method is performed. To this end, the depth estimating unit estimates depth information using the RGB image information and the image warping unit generates an image which is warped on the basis of the depth information estimated by the depth estimating unit to update the pose estimated by the pose estimating unit.

Desirably, in order to normalize data into a form that may compute the deep learning-based VIO, the data computing unit extracts feature information required to estimate the pose by convolution computation of each data based on deep learning and determines whether to use image feature information, among the extracted feature information. By doing this, the image computation process may be optionally omitted to estimate the camera pose in real time.

To be more specific, the data computing unit performs a 2D convolution computation on the RGB data and extracts image feature information corresponding to a texture, an edge, or a color pattern by the 2D convolution computation. The 2D convolution computation process on the RGB data is as represented in the following Equation 1 and the 2D convolution computation is a process of moving a convolution kernel K over an image I, multiplying the kernel and the corresponding part of the image element by element, and then adding the results.

$$C ( x , y ) = {\sum }_{i = - 1}^{1} {\sum }_{j = - 1}^{1} I ( x + i , y + j ) \cdot K ( i , j ) \qquad [ Equation 1 ]$$

Here, K(i, j) is a specific element of the convolution kernel and I(x+i, u+i) is an element of the image on the same position.

In an exemplary embodiment, the data computing unit may learn to estimate an optical flow to extract image feature information and update a weight of the deep learning algorithm to calculate a variance of the RGB data and minimize a computational error for the pose of the camera according to the variance. Here, the variance of the RGB data refers to a variance of each pixel of continuous frames (for example, t, t+1, t+2, . . . ).

Desirably, the data computing unit may perform 1D convolution computation on inertia data and extract inertia feature information corresponding to a pattern or the change over time, through the 1D convolution computation. The data computing unit performs 1D convolution computation on the inertia data as represented in the following Equation 2. Here, the 1D convolution is applied to time-series data or 1D signal and the inertia data sequence is assumed as a 1D signal to perform the computation. A convolution result C(x) in a specific position x is calculated as represented in the following Equation 2 and the convolution result value corresponds to inertia feature information.

$$C ( x ) = {\sum }_{i = - 1}^{1} D ( x + i ) \cdot K ( i ) \qquad [ Equation 2 ]$$

Here, D(x+1) is a corresponding position value of the inertia data sequence and K(i) is an element of the convolution kernel.

Desirably, the data computing unit may determine whether to use image feature information. To be more specific, the data computing unit may calculate an output value corresponding to a specific element on the basis of inertia feature information and a previous viewpoint output result of a long short-term memory (LSTM) through the following Equation 3. Here, the specific element refers to feature information required to determine a vision. Since a shape of the input data has a multi-dimensional arrange format, a specific element may be used to create the same result as the size of the input data.

$${c}_{t} = [ {h}_{t - 1} ; {e}_{t} ] \qquad [ Equation 3 ]$$

$${select}_{t} ( x ) = {\sum }_{i = - α}^{α} {c}_{t} ( x + i ) \cdot K ( i )$$

Here, cₜ is input value, hₜ₋₁ is a previous viewpoint output result of the long short term memory, et is inertia feature information, and selecₜ(x) is an output value corresponding to a specific element x of cₜ through 1D convolution as a computation result.

Next, the data commutating unit applies Gumbel-Softmax to the output value to produce a probability value in order to make the deep learning model binary-selectable and differentiable, and then multiplies the probability value by the output value (that is, the convolution result value) to change the output value to 0 or 1. Here, the Gumbel-Softmax computation is a method of transforming a discrete probability distribution into continuous approximation and allows the deep learning model to learn on the basis of gradient, thereby determining whether the image feature information is used.

The pose estimating unit estimates a pose of the camera on the basis of the used image feature information which is determined to be used depending on whether to use the image feature information and the inertia feature information. Here, the used image feature information corresponds to image feature information whose output value is filled with 1. Desirably, the pose estimating unit may estimate a translation vector and a rotation vector, calculate orientation transformation, and calculate a trajectory of the camera pose. This expects how much the camera moves with respect to the previous viewpoint frame. The translation vector estimates how much the camera moves from the previous viewpoint frame through the deep learning algorithm and has the position of the previous viewpoint frame as a criterion and the rotation vector also estimates how much the camera moves from the previous viewpoint frame through the deep learning algorithm similar to the translation vector.

Desirably, the pose estimating unit may form a tensor by concatenating the used image feature information and the inertia feature information with a dimensional axis, acquire a current viewpoint output result of the long short term memory on the basis of the tensor and the previous viewpoint output result of the long short term memory, and represent the current viewpoint output result with a vector for each axis through a fully connected layer. To be more specific, the pose estimating unit may concatenate the used image feature information and the inertia feature information with a last dimensional axis. Here, the tensor concatenated by the dimensional axis may learn long and short term dependency from the time series data through the long short term memory (LSTM) layer. That is, the long short term memory reflects the previous output result to predict from the new data and identifies a pattern over time from the continuous image or the inertia data to improve the pose estimation performance. That is, similar to the RGB data, continuous change is also given to the inertia data so that when the long short term memory is used, the prediction performance may be improved and how the inertia data value changes in accordance with the flow of time may be reflected.

Desirably, the pose estimating unit may represent an output result of the long short term memory as a vector for each axis through the fully connected layer. That is, a final value output through the pose estimating unit is a translation vector and a rotation vector which represent a pose of the camera.

That is, the pose estimating unit may estimate a variance of a camera pose of continuous two frames by repeating processes of acquiring data and extracting and matching feature information, estimating a translation vector, and calculating orientation transformation. When the camera trajectory calculated as described above is used, an estimation task required for the SLAM may be performed and this task refers to a mapping task which configures information about surrounding environment on the global space (3D space) by means of the self-localization.

In one exemplary embodiment, a binary determining process for determining whether to use image feature information is differentiable through Gumbel-Softmax to learn the weight through the loss function. The loss function of the data positioning apparatus 100 may be defined as a sum of a loss function for determining whether to use image feature information and a loss function for estimating a pose of a camera. Specifically, in the loss function for determining whether to use the image feature information, a penalty term is applied as a temperature parameter of the Gumbel-Softmax as represented in Equation 4 and in the loss function for estimating the pose of the camera may correspond to the square loss of the Euclidean norm (L2) of the translation vector and the rotation vector representing the pose of the camera, as in Equation 5 below.

$${Loss}_{selection} = \frac{1}{seq - 1} {\sum }_{t = 1}^{seq - 1} λ {g}_{t} \qquad [ Equation 4 ]$$

Here, seq is a length of sequence, λ is a penalty term, and gₜ is a result value obtained by applying Gumbel-Softmax to an output value.

$${Loss}_{pose} = \frac{1}{seq - 1} {\sum }_{t = 1}^{seq - 1} ( {‖ \vec{{υ}_{t}^{′}} - \vec{{υ}_{t}} ‖}_{2}^{2} + α \times {‖ \vec{{r}_{t}^{′}} - \vec{{r}_{t}} ‖}_{2}^{2} ) \qquad [ Equation 5 ]$$

Here, seq is a length of sequence, a=100, \vec{v} is a translation vector, and \vec{r} is a rotation vector.

In one exemplary embodiment, the depth estimating unit and the image warping unit update a pose estimated by the pose estimating unit to optimize the camera pose. To be more specific, the depth estimating unit receives an RGB image through the data input unit and estimates depth information using the RGB image data. Here, the depth estimating unit is an AI module which estimates depth information using the image information and corresponds to an auto-encoder-based depth estimation model and trains the depth estimation model using depth data which is visual data corresponding to 3D acquired from the stereo camera. In the case of the stereo camera, a depth value corresponding to a left eye image and a right eye image may be extracted and images corresponding to a left eye and a right eye may be individually extracted as the RGB images. Desirably, the depth estimating unit may estimate the depth value on the basis of the RGB image and generate a depth map on the basis of the RGB image.

The image warping unit generates a warped image using the depth map generated in the depth estimating unit and updates an estimated pose on the basis of the warped image and the estimated pose provided from the pose estimating unit. Desirably, the image warping unit calculates 3D points using a depth value provided from the depth estimating unit for each pixel of the image and applies the predicted camera orientation transformation to convert the 3D points into the target camera coordinate system. To be more specific, the image warping unit predicts a camera movement between a source frame given through the deep learning model and a target frame which is captured at a specific time t to generate a transformation matrix and applies the transformation matrix with respect to the camera coordinate system in the target frame to align the source frame to the target frame. Here, the transformation matrix represents a relative camera position and direction change from the target frame to the source frame and corresponds to a predicted camera orientation transformation. That is, in the coordinate system of the target frame, the 3D coordinate of the source frame is transformed by the predicted camera orientation transformation. Thereafter, the image warping unit projects the transformed 3D points on a target image plane corresponding to an image plane of the target frame to acquire a new pixel coordinate and samples a pixel value corresponding to each pixel coordinate from the target image to generate a warped image.

Desirably, the image warping unit calculates a loss by comparing the warped image and the source image and trains the model therethrough. That is, the image warping unit calculates the loss by comparing the pixel value on the target image plane and the warped pixel value of the source frame. At this time, the source image is projected to the target image so that it is evaluated whether the pixel of the source frame is well matched to the target frame.

In one exemplary embodiment, the loss is updated on the basis of a depth map estimated in the depth estimating unit and depth data (that is, depth image) corresponding to 3D visual data acquired from the stereo camera to update the pose estimated by the pose estimating unit. That is, a difference between the prediction result by the deep learning model and a correct result is calculated (for example, differentiated) to update a weight of the deep learning model applied to the present disclosure to train the deep learning model.

The graph optimizing unit updates a camera pose for the current frame to the camera pose trajectory for the previous frame, examines outlier data, and optimizes the trajectory. Desirably, the graph optimizing unit is a module which optimizes a trajectory for the predicted camera poses and when the camera poses are accumulated or a loop is generated in the graph trajectory, may update a camera pose corresponding to the loop. The graph optimizing unit combines a bundle adjustment (BA) used for the existing SLAM and a loop closure algorithm to continuously optimize camera pose data acquired from the pose estimating unit in real time.

In the meantime, steps of the method or algorithm described in connection with the exemplary embodiment of the present disclosure may be directly implemented by hardware or implemented by a software module executed by the hardware or a combination thereof. The software module may reside on RAM (random access memory), ROM (read only memory), EPROM (erasable programmable ROM), EEPROM (electrically erasable programmable ROM), a flash memory, a hard disk, a removable disk, a CD-ROM, or an arbitrary computer readable recording medium which is well-known in the technical field of the present disclosure.

Components of the present disclosure are implemented as a program (or an application) to be coupled to a computer which is hardware to be executed and stored in a medium. Similar to execution of the components of the present disclosure with software programming or software elements, the exemplary embodiment may be implemented by programming or scripting languages such as C, C++, Java, assembler including various algorithms implemented by a combination of data structures, processes, routines, or other program configurations. The functional aspects may be implemented by an algorithm executed in one or more processors.

The preferred exemplary embodiments for an apparatus and a method for positioning indoor space data according to the above-described present disclosure have been explained, but the present disclosure is not limited thereto and modified in range e of claims, the detailed various forms within the description of the present disclosure, and the accompanying drawings, which also belongs to the present disclosure.

What is claimed is:

1. A data positioning apparatus, comprising:
a stereo camera which acquires visual data corresponding to 2D and 3D;
an inertial measurement unit which acquires inertia data corresponding to acceleration and angular velocity data; and
a computing module which receives data acquired from the stereo camera and the inertial measurement unit and performs computation of a visual SLAM engine.

2. The data positioning apparatus according to claim 1, wherein the stereo camera acquires an RGB image corresponding to 2D data and depth data corresponding to 3D data.

3. The data positioning apparatus according to claim 1, wherein the computing module includes:
a data input unit which receives an RGB image and depth data from the stereo camera and inertia data from the inertial measurement unit;
a data computing unit which normalizes the RGB image and the inertia data;
a pose estimating unit which estimates a pose with six degrees of freedom for a current frame using the normalized data; and
a graph optimizing unit which updates a camera pose trajectory on the basis of the estimated pose.

4. The data positioning apparatus according to claim 3, wherein the data computing unit performs a 2D convolution computation on the RGB data and extracts image feature information corresponding to a texture, an edge, or a color pattern by the 2D convolution computation.

5. The data positioning apparatus according to claim 4, wherein the data computing unit calculates a variance of the RGB data and updates a weight to minimize a calculation error for the pose of the stereo camera according to the variance.

6. The data positioning apparatus according to claim 4, wherein the data computing unit performs a 1D convolution computation on the inertia data and extracts inertia feature information corresponding to a pattern or a change over time by the 1D convolution computation.

7. The data positioning apparatus according to claim 6, wherein the data computing unit calculates an output value corresponding to a specific element on the basis of the inertia feature information and a previous viewpoint output result of a long short term memory, calculates a probability value by applying Gumbel-Softmax to the output value, and products the probability value and the output value to change the output value to 0 or 1 to determine whether to use the image feature information.

8. The data positioning apparatus according to claim 7, wherein the pose estimating unit forms a tensor by concatenating used image feature information determined to be used depending on whether to use the image feature information and the inertia feature information with a dimensional axis, acquires a current viewpoint output result of the long short term memory on the basis of the tensor and the previous viewpoint output result of the long short term memory, and represents the current viewpoint output result with a vector for each axis through a fully connected layer.

9. The data positioning apparatus according to claim 3, further comprising:
a depth estimating unit which is an auto-encoder-based model to estimate a depth value from the RGB image and generate a depth map.

10. The data positioning apparatus according to claim 9, further comprising:
an image warping unit which generates a warped image using the depth map received from the depth estimating unit and updates a pose on the basis of the warped image and a pose estimated by the pose estimating unit.

11. The data positioning apparatus according to claim 10, wherein the depth estimating unit calculates a 3D point using a depth value for each pixel of the RGB image and the image warping unit transforms the 3D points into a target camera coordinate system by applying a predicted camera orientation transformation, acquires a pixel coordinate by projecting the transformed 3D points onto a target image plane, and generates a warped image by sampling a pixel value corresponding to the pixel coordinate from the target image.

12. The data positioning apparatus according to claim 3, wherein the graph optimizing unit updates a pose estimated for the current frame to the pose trajectory estimated for a previous frame, examines outlier data, and optimizes the trajectory.

13. The data positioning apparatus according to claim 12, wherein the graph optimizing unit optimizes data for the estimated pose in real time on the basis of bundle adjustment (BA) and a loop closure algorithm when a loop is generated in the camera pose trajectory due to accumulation of the estimated pose.

14. The data positioning apparatus according to claim 1, further comprising:
a visualization module which visualizes data acquired from the stereo camera, the inertial measurement unit, or the computing module and outputs the data to a display.

15. The data positioning apparatus according to claim 14, wherein the visualization module outputs a function of visualizing and outputting the RGB image, the depth map, or the point cloud acquired from the stereo camera and controlling an operation of the data positioning apparatus and a function for controlling a display screen.

16. A data positioning method which is performed in a computing module of a data positioning apparatus, comprising:
a step of receiving visual data corresponding to 2D and 3D acquired from a stereo camera and acceleration and angular velocity data acquired from an inertial measurement unit; and
a step of performing a computation of a visual SLAM engine on the basis of the received data.

17. The data positioning method according to claim 16, wherein the step of performing a computation of a visual SLAM engine includes:
a step of normalizing an RGB image corresponding to the 2D data and inertia data corresponding to the acceleration and the angular velocity data;
a step of estimating a pose with six degrees of freedom for a current frame using the normalized data; and
a step of updating a camera pose trajectory on the basis of the estimated pose.

18. The data positioning method according to claim 17, wherein the step of performing a computation of a visual SLAM engine includes:
a step of estimating a depth value from the RGB image and generating a depth map;
a step of generating a warped image using the depth map; and
a step of updating a pose on the basis of the warped image and the estimated pose.

19. A computer program stored in a computer readable medium
in which when an instruction of the computer program is executed, the method according to claim 16 is performed.
